(19) United States
(12) Patent Application Publication
(10) Pub. No.: US 2016/0023846 A1
(43) Pub. Date: Jan. 28, 2016

(54) Temporary Plastic Bag Trash Receptacle

(71) Applicant: Richeal Wheeler, Bonney Lake, WA (US)

(72) Inventor: Richeal Wheeler, Bonney Lake, WA (US)

(21) Appl. No.: 14/811,744

(22) Filed: Jul. 28, 2015

Related U.S. Application Data
(60) Provisional application No. 62/029,712, filed on Jul. 28, 2014.

(51) Int. Cl. B65F 1/14; B65F 1/00

(52) U.S. Cl. CPC B65F 1/1415; B65F 1/0006; B65F 2210/18

(57) ABSTRACT

A trash receptacle including a rigid frame that includes a longitudinal member, two side members attached to form on the opposite ends of the longitudinal member. Extending laterally from the two side members are two handles. The rear frame member, the two side members and the two handles are aligned in a same horizontal plane. The two side members and handle are parallel and perpendicularly aligned with the rigid frame's longitudinal member. Attached or formed on the ends of the two side members'are edge capturing structures configured to temporarily hold the rigid frame laterally from the edge of the countertop or work table. In one embodiment, the edge capturing structures are C-shaped brackets configured to slide and extend over the top and bottom surfaces of the countertop or work table. In another embodiment, the edge capturing structures are clamps with two legs that press against the top and bottom surfaces of the countertop or work station. An optional tray that fits over the top surface of the rigid frame 20 may be provided.

This utility patent application is based upon and claims the filing date benefit of U.S. provisional patent application (Application No. 62/029712) filed on Jul. 28, 2014.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains to trash receptacles, and more particularly to trash receptacles that attach to the overhanging edge adjacent to a kitchen countertop or work table that holds a plastic, disposable shopping bag with two handles in a hands-free open configuration adjacent to the countertop or work table so that trash may be swept off the countertop or work table and directly into the bag.

2. Description of the Related Art

Inexpensive, disposable light weight plastic shopping bags are commonly handed out by retail stores to customers. Such bags can be stored in a flat configuration in a box and then selected and expanded to accommodate different amounts of merchandise. Such bags are available in different sizes 4 to 7 inches in width, 7 to 12 inches in length and 12 to 21 inches in height. They include a closed bottom surface, a wide top opening, and two integrally formed handles on opposite sides of the bag. They are typically made of a single, thin layer of plastic (0.5ml) making inexpensive and recyclable. Because these plastic bags are widely distributed to every shopper, shoppers typically have a large collection of used plastic bags in their pantries.

Today, cooking is becoming a very popular with young and middle age adults. Such individuals live in houses with large kitchens that have large flat countertops and work tables where meals may be prepared. The countertops and work tables are made of durable plastic or made from decorative granite or quartz with edges 1 to 1½ inches thick. They often have front edges that hang over the front edge of a lower cabinet.

What is needed is a trash receptacle that can be temporarily attached to the overhanging edge of a countertop or work table that holds a disposable plastic bags commonly used by retail businesses in an open extended position adjacent to the countertop or work table that allows the user to sweep trash and food material generated on the countertop or work table and deposit it directly into the plastic bag.

### SUMMARY OF THE INVENTION

Disclosed herein is a trash receptacle that includes a rigid frame that includes a longitudinal member, two side members attached or formed on the opposite ends of the longitudinal member. The area between the longitudinal member and the two side members is open. When the rigid frame is attached to countertop or a work table, the open area forms a rectangular-shaped top bag opening configured to received a stretched disposable plastic shopping bag.

During installation, the longitudinal member is positioned parallel to the overhanging edge on the countertop or work table. The two side arms are parallel and perpendicularly aligned with the longitudinal member. Attached or formed on the ends of the two side members are edge capturing structures configured to temporarily hold the rigid frame laterally from the edge of the countertop or work table and substantially below the top surface of the top surface of the countertop or work table. The edge capturing structures may be configured to position the rigid frame even or flush with the lower surface of the countertop or work table.

In one embodiment, the edge capturing structures are C-shaped brackets configured to slide and extend over the top and bottom surfaces of the countertop or work table. The brackets include an L-shaped top rod and a straight lower rod. The two rods are spaced apart to fit around the edge with the lower rod being even or flush with the lower surface of the countertop or work table.

In another embodiment, the edge capturing structures are two baised clamps each with two legs that press against the top and bottom surfaces of the countertop or work table. The lower leg on each clamp is mounted or attached to the top surface of the side member.

In two embodiments shown herein, the extending laterally from the two side members are two handles that enable the user to grip and move the rigid frame to different locations on the countertop and work table.

The rear frame member, the two side members and the two handles are aligned in the same horizontal plane parallel to and approximately even of flush with the bottom surface of the countertop or work table. The spacing of the longitudinal member and the two side members are sufficient so that when the top opening of a disposable plastic bag is pulled opened , its top inside edge is adjacent to the lower corner of the overhanging edge on the countertop or work table.

In some embodiments described above, the rigid frame includes at least one longitudinal member and two side members with the longitudinal member being a fixed length. It should be understood however, the rigid frame may include two longitudinal members (one outside and one inside near the edge). It should also be understood the single or two longitudinally members may be adjustable in length thereby enabling the rigid frame to be adjustable in length to accommodate different size bags.

During use, the rigid frame is placed against a desired overhanging edge on the countertop or work table so the bag's top opening when the bag is placed into the bag opening is longitudinally aligned and substantially parallel to the overhanging edge. The two end capturing structures are then attached to the edge to temporarily hold the rigid frame in a suspended position from the overhanging edge. When installing a disposable plastic bag into the rigid frame, the bag is held upright and stretched so that the bag's two hand loops are positioned adjacent to the two opposite side members. Depending on the size of the bag, the two hand loops are then pulled laterally and extended over or under the two clamps or two handles to hold the bag on the rigid frame. The closed end of the bag is then pressed downward to expand the bag inside the frame's top bag opening. Trash from the countertop or work table may then be swept laterally across the countertop or work table and deposited directly into the bag. Because the inside edge of the bag is located adjacent to the edge and below the top surface, trash falls directly into the bag and not on the floor. When full, the bag may be removed and easily replaced with another bag.

### DESCRIPTION OF THE DRAWINGS

FIG. 1 is a top perspective view of plastic bag trash receptacle temporarily attached to the edge of a countertop.

FIG. 2 is a side perspective view of the plastic bag trash receptacle shown in FIG. 1.

FIG. 3 is a top plan view of the rigid frame.

FIG. 4 is a front elevational view of the rigid frame showing the location of a plastic bag when attached thereto.

FIG. 5 is a side elevational view of the rigid frame shown in FIG. 4.

FIG. 6 is a top perspective view of a second embodiment of the plastic bag trash receptacle temporarily attached to the edge of a countertop.

FIG. 7 is a top plan view of the plastic bag trash receptacle shown in FIG. 6.

FIG. 8 is a top plan view of a third embodiment of the plastic bag trash receptacle that includes two clamping members and two handles. Also shown in the rigid frame is adjustable in length.

FIG. 9 is a front elevational view of the receptacle shown in FIG. 8 showing the length of the rigid frame being adjusted.

FIG. 10 is a perspective view of the frame shown an optional tray that may be placed or the top surface of the frame.

### DESCRIPTION OF THE PREFERRED EMBODIMENT(S)

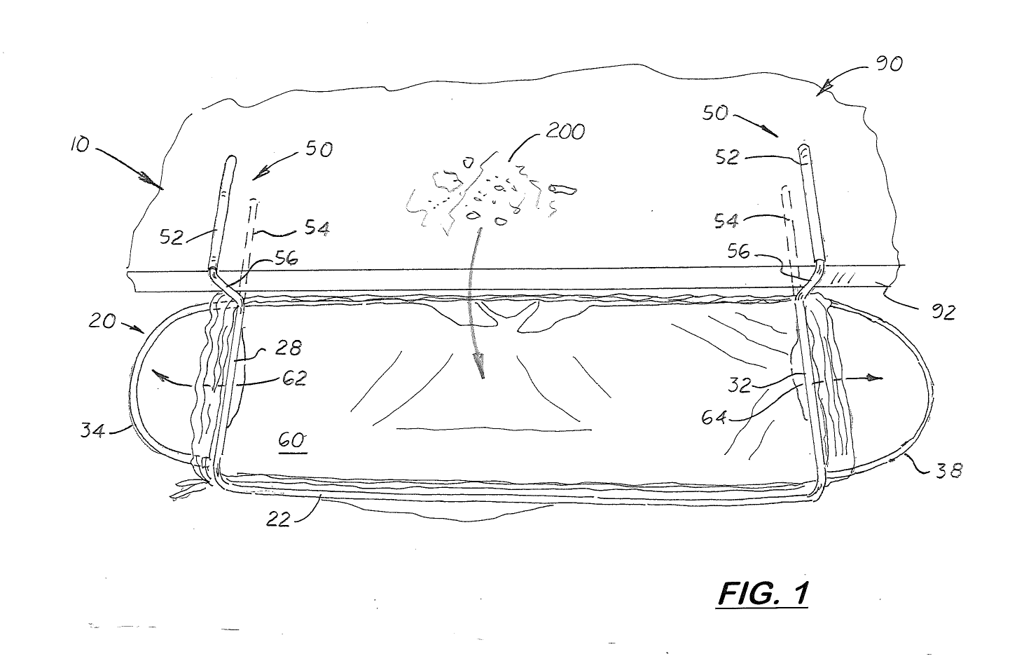

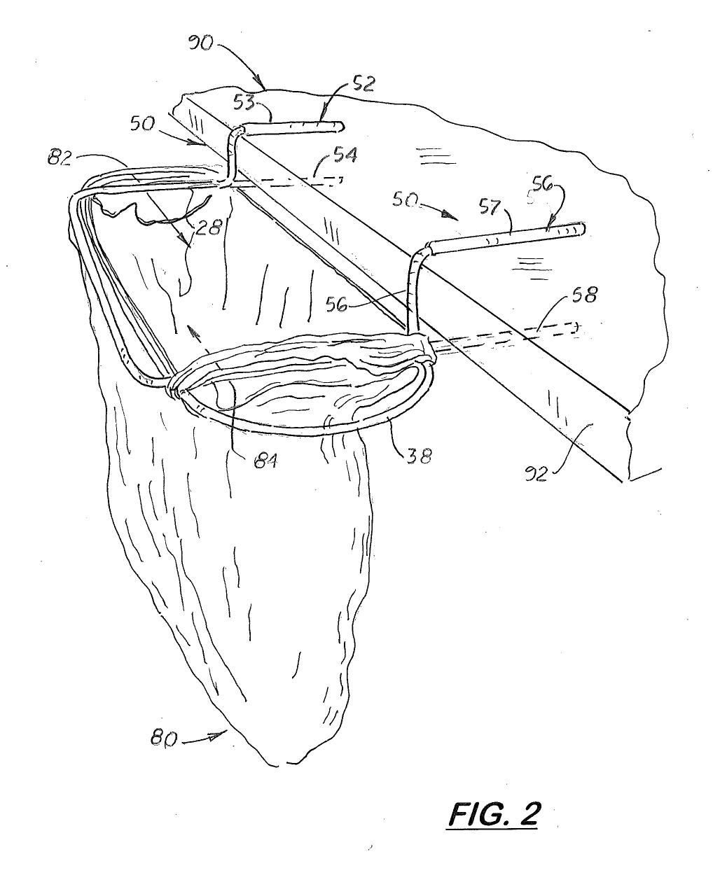

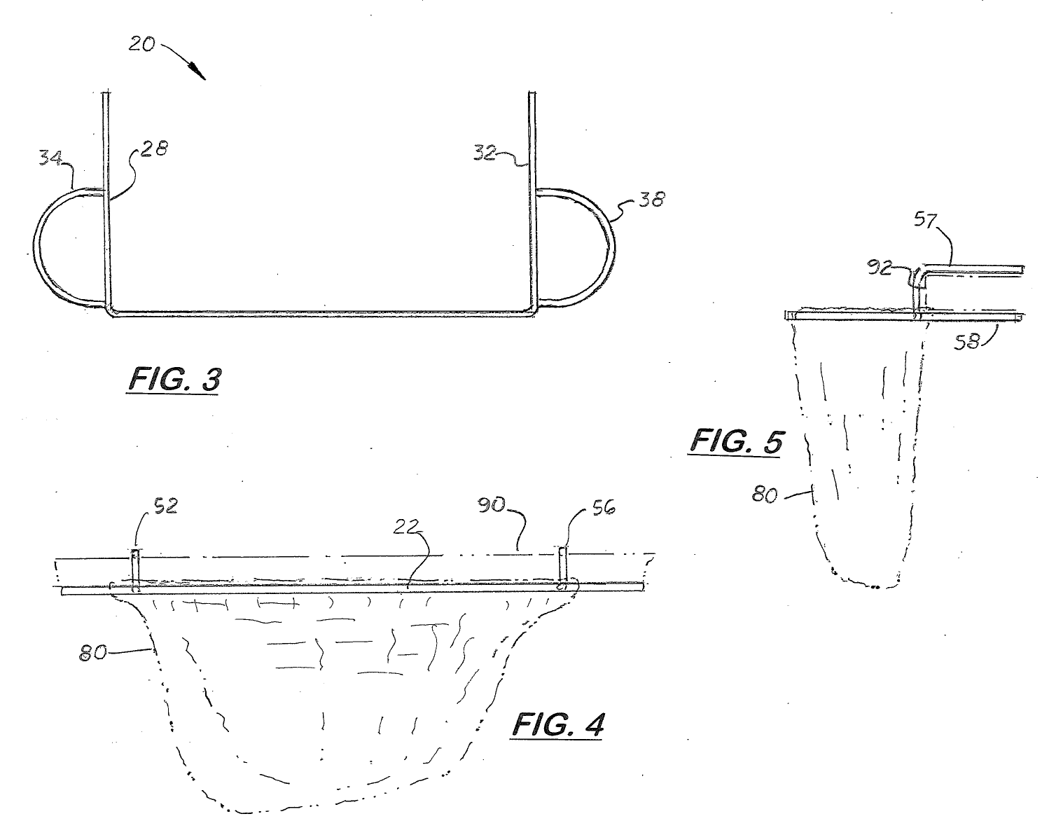

Referring to the FIGS. 1-9, there is shown a plastic bag trash receptacle 10 designed to temporarily attach to the overhanging edge 92 of a countertop or work table 90. The receptacle 10 includes a rectangular rigid frame 20 that includes a longitudinal member 22, two side members 28, 32 attached to formed on the opposite ends of the longitudinal member 22. Extending laterally from the two side members 28, 32 are two handles 34, 38, respectively. The longitudinal member 22, the two side members 28, 32 and the two handles 34, 38 are aligned in a single horizontal plane (denoted as ‘X’) substantially even or flush with the lower surface of the countertop or work table 90.

In the embodiment shown herein, the two side arms 28 32 are parallel and perpendicularly aligned with the longitudinally member 22. Attached or formed on the ends of the two side members 28, 32 are edge capturing structures 50 configured to temporarily hold the rigid frame 20 laterally from the overhanging edge 92 of the countertop or work table 90. In one embodiment shown in FIGS. 1-5, the edge capturing structures 50 are C-shaped brackets 52, 56 each with a horizontal upper rod 53, 55 and a horizontal lower rod 54, 58 respectively. The rods 53, 54 and 56, 58 are sufficiently spaced apart to fit over the edge 92 and slide horizontally over the top and bottom surfaces, respectively, of the countertop or work table 90.

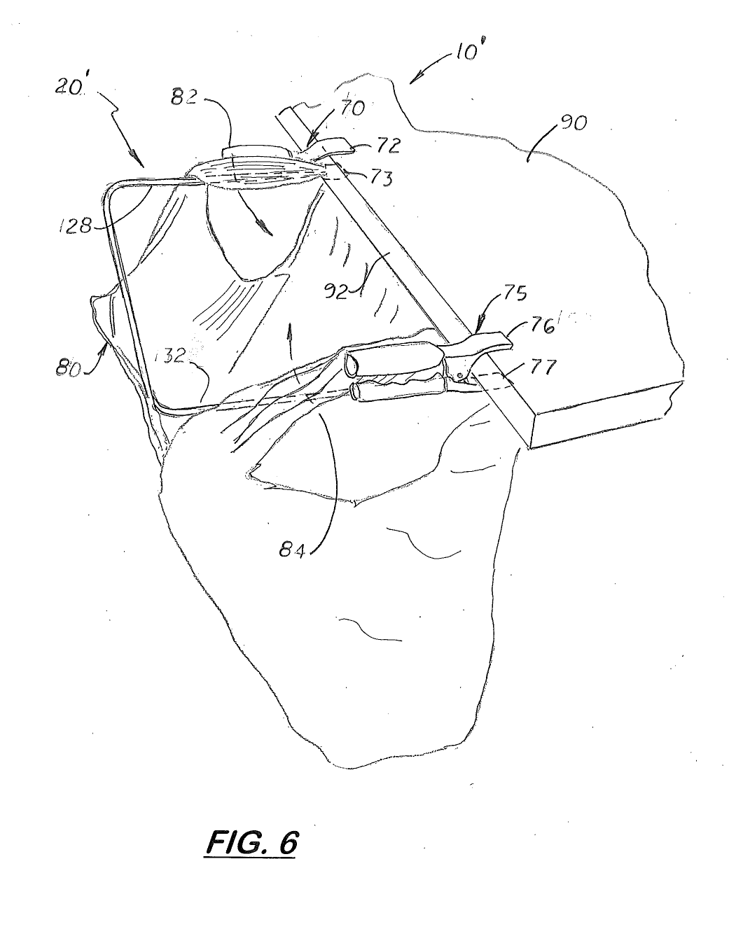

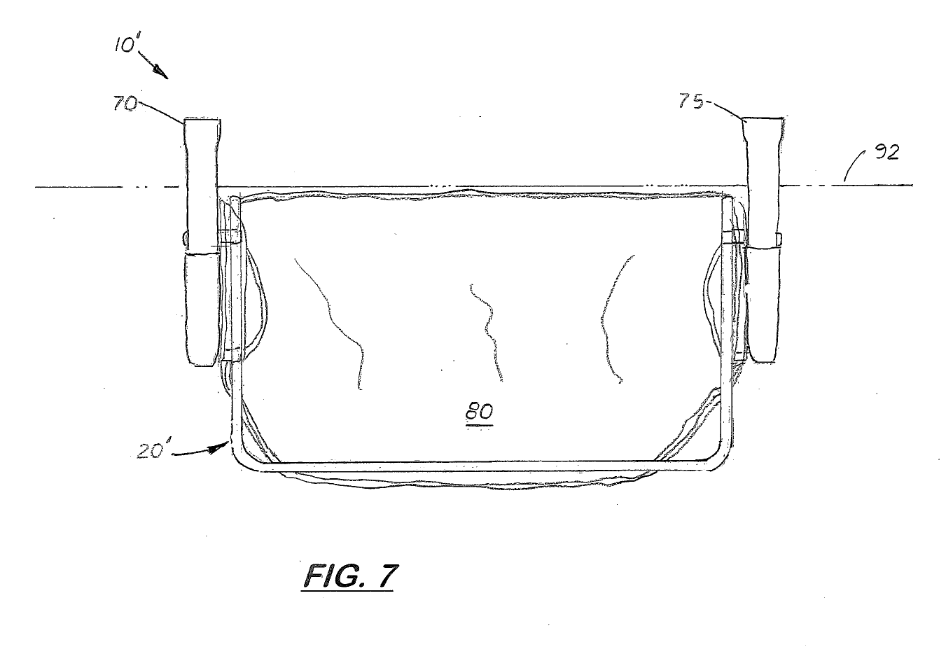

In a second embodiment of the bag trash receptacle, denoted 10′, shown in FIGS. 6 and 7, the edge capturing structures 50 are two clamps 70, 75 each with two legs 72, 73 and 76, 77 that press against the top and bottom surfaces, respectively, of the countertop or work station 90. The lower legs 73, 76 of each clamp 70, 75 are aligned with or attached to the top surface side member 28, 32, respectively. In receptacle 10′ shown in FIG. 7, the two handles 34, 38 are eliminated.

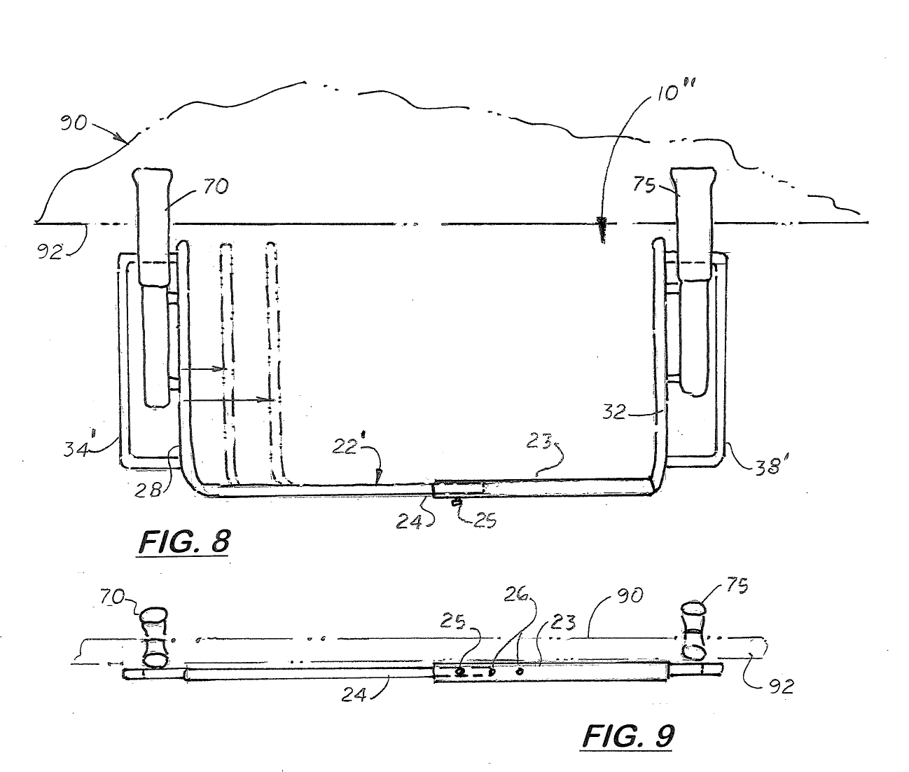

In a third embodiment shown in FIGS. 8 and 9, the edge capturing structures 50 are two clamps 70, 75 and two rectangular shaped handles 34′ 38′ that extend outward from each side member 28, 32, respectively.

The rigid frame 20 is designed to be used with a plastic shopping bag 80 that measures 4 to 7 inches in width, 7 to 12 inches in length, and 12 to 21 inches in height. The bag 80 has a top opening 81, two hand loops 82, 84 and a closed bottom 86.

The rigid frame 20 is made of solid or tubular plastic or metallic material ⅛ to ¼ inches thick. The rigid frame 20 measures approximately 7 to 14 inches in length and 6 to 9 inches in width.

During use, the rigid frame 20 is placed against a desired front or side edge 92 of the countertop or work station 90 so the frame's longitudinal axis 21 is substantially parallel to the edge 92. Depending on the embodiment being used, either the C-shaped brackets 52, 56 or the clamps 70, 75 are attached to the edge 92 to temporarily hold the rigid frame 20 in place. A disposable plastic bag 80 with two hand loops 82, 84 is then selected and held upright to the closed bottom 86 extends into the frame's top opening. Depending on the size of the bag 80, the two hand loops 82, 84 are then pulled laterally and extended over or under the two side members 28, 32, the two handles 34, 38, for around the two clamps 70, 75. The closed bottom 86 of the bag 80 is then pressed downward extending the bag and positioning the closed bottom 86 below the rigid frame 20. Trash 200 from the countertop or work table 90 may then be pushed laterally across the countertop or work table 90 and into the main body. When full, the bag 80 may be removed and replaced with another bag.

In the embodiments described above, the rigid frame 20 includes at least one longitudinal member 22 and two side members 28 32. The longitudinal member 22 has a fixed length. It should be understood however, the rigid frame 20 may include a second longitudinal member, (two total with one outside and one inside near the edge) for additional support. It should also be understood the single or two longitudinally members 22 may be adjustable in length thereby enabling the rigid frame to be adjustable in length to accommodate different size bags as shown in FIGS. 8 and 9. In the embodiment shown in FIGS. 8 and 9, the longitudinal member (denoted 22′) comprises two tube sections 23 and 24 that are telescopically joined together. A threaded connector 25 fits into threaded holes 26 formed on the two tube sections 23, 24 that lock the tube sections together at a fixed length.

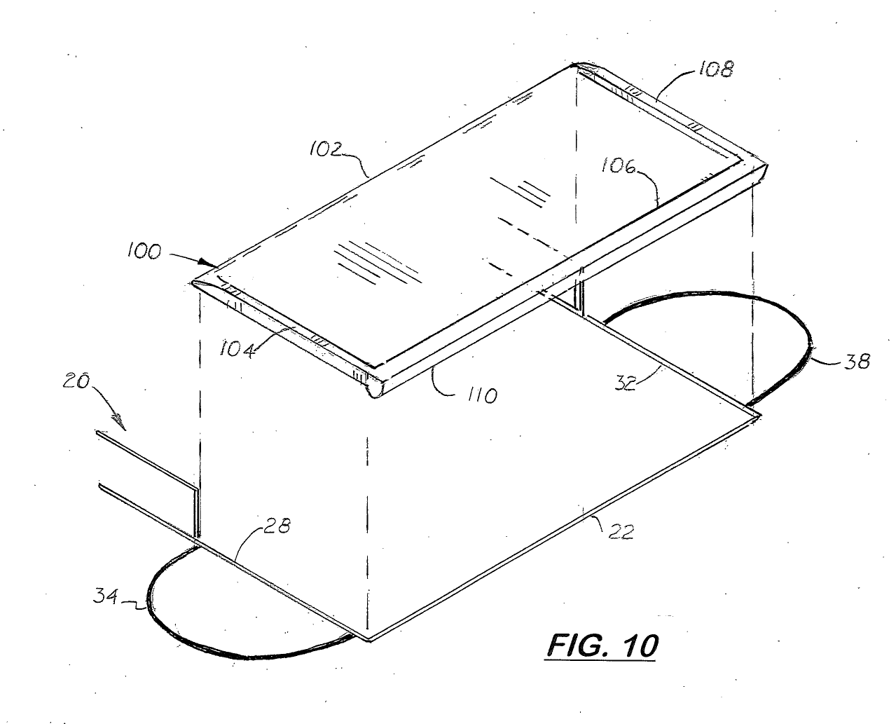

FIG. 10 is a perspective view of the rigid frame 20 showing an optional tray 100 that may be placed or the top surface of the rigid frame 20 that may be used to transport cuttings from the countertop to another pan or container. The tray 100 is a rectangular structure configured to rest over the top surfaces of the longitudinally member 22 and the two side members 28, 32. The tray 100 includes a tampered front edge 102 and three raised edges, 104, 106, 108. The front edge 106 may include a downward extending lip 110 that fits over the longitudinal member 22 to hold the tray over the rigid frame 20. During use, the tray 100 can be easily placed over the rigid frame 20 and used to collect cuttings or removed so that trash may be deposited into the trash bag.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A trash receptacle, comprising:
a. a frame that includes a longitudinal member, two perpendicularly aligned side members attached at their opposite ends to said longitudinal member forming a top bag opening, attached to each said side member is a handle member aligned, said longitudinal member, said side members and said arm members aligned in a single horizontal plane;
b. an edge capturing structure attached or formed on said frame, said edge capturing structure configured to temporarily hold said rigid frame laterally from an exposed overhanging edge and below the top surface of a countertop or work table; and,
c. a disposable plastic bag with a top bag opening, a closed bottom and continuous side walls, said plastic bag includes two handle loops, said plastic bag having a sufficient size so that when said bag is extended through said bag opening in said frame and stretched so that said hand loops extend and wrap around said side arms to hold said bag over said frame.

2. The trash receptacle, as recited in claim 1, wherein said edge capturing structure are two C-shaped brackets formed or attached to said side members, each said bracket includes an upper rod and a lower rod parallel that are parallel and sufficiently spaced apart to extend over a top and bottom surface of said edge and hold said frame laterally from said edge.

3. The trash receptacle, as recited in claim 1, wherein said edge capturing structure are two biased clamps, each said clamp being attached to said side member and perpendicularly aligned with said longitudinal members, each said clamp being configured to grip said edge to hold said frame laterally from said edge.

4. The trash receptacle, as recited in claim 1, wherein said longitudinal member is adjustable in length.

5. The trash receptacle , as recited in claim 1, further including a tray configured to rest over said rigid frame.

6. The trash receptacle, as recited in claim 3, wherein said longitudinal member is adjustable in length.

7. The trash receptacle, as recited in claim 3, further including a tray configured to rest over said rigid frame and cover said top bag opening.

8. The trash receptacle, as recited in claim 7, further including a downward lip formed on said tray that extends over said longitudinal member when said tray is placed over said top bag opening.
